(19) United States
(12) Patent Application Publication
(10) Pub. No.: US 2017/0171323 A1
(43) Pub. Date: Jun. 15, 2017

(54) Dynamic Assignment of Phone Numbers for Call Forwarding

(71) Applicant: ZenPhone LLC, Sedona, AZ (US)

(72) Inventors: Jay Andrew Wadley, Sedona, AZ (US); Adrian Kush Patel-Delaloye, Sedona, AZ (US)

(21) Appl. No.: 15/431,428

(22) Filed: Feb. 13, 2017

Related U.S. Application Data
(60) Provisional application No. 62/267,047, filed on Dec. 14, 2015.

(51) Int. Cl. H04L 29/08; H04L 29/12

(52) U.S. Cl. CPC H04L 67/18; H04L 67/02; H04L 61/605

(57) ABSTRACT

Disclosed herein are system, method, and computer program product embodiments for dynamically providing a local phone number to a user based on a geolocation. An embodiment operates by receiving, from a client device through a communications network, a first request for content. The system then determines a geolocation of a client device based on information included in the request. An embodiment then sends, to the client device through the communications network, instructions that cause the client device to send a second request with the determined geolocation and receive a local phone number based on the geolocation for display.

### BACKGROUND

Technical Field

Embodiments generally relate to communications between computer systems.

Background

The growth and access to the Internet has resulted in individuals and companies increasingly conducting business across international borders. People are more likely than ever to procure products or services from others in different countries. However, there are still barriers and disincentives to conducting business internationally versus locally. For example, although voice communication across the Internet may be easier than before, many still prefer the convenience of dialing a local phone number to instantly talk to someone.

### SUMMARY

Disclosed herein are system, method, and computer program product embodiments for dynamically providing a local phone number to a user based on a geolocation. An embodiment operates by receiving, from a client device through a communications network, a first request for content. The system then determines a geolocation of a client device based on information included in the request. An embodiment then sends, to the client device through the communications network, instructions that cause the client device to send a second request with the determined geolocation and receive a phone number based on the geolocation for display.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

The accompanying drawings are incorporated herein and form a part of the specification.

FIG. 1 shows a system environment for dynamically providing a local phone number based on a geolocation, according to an example embodiment.

FIG. 2 illustrates an example user interface provided by a server device for display in a client device, according to an example embodiment.

FIG. 3 illustrates a user interface for a customer of a phone assignment system, according to an example embodiment.

FIG. 4 illustrates a method for dynamically providing a local phone number to a user based on a geolocation, according to an example embodiment.

FIG. 5 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program product embodiments, and/or combinations and sub-combinations thereof, for dynamically providing a local phone number to a user based on a geolocation.

Currently, individuals or businesses that want to receive no-charge calls from international customers may have to procure a phone number and forwarding services with a phone service provider in each country of interest. For example, if a business in France wants to receive calls from customers in the U.S. (without having the customers make a long-distance call), the business may need to procure a U.S. phone number and have calls to the number forwarded to a number in France. Furthermore, the individual or business may need to list multiple phone numbers on their website and have the customers call the appropriate number.

In particular embodiments, an online system may be configured to determine a geolocation of a client and display a phone number that is local to the client. For example, the system may determine a client's country based on the client's Internet Protocol (IP) address. The system may then procure or assign a phone number that is local to the client's country and display the number for the client (e.g., on a webpage). The client may then dial the number without incurring long-distance fees.

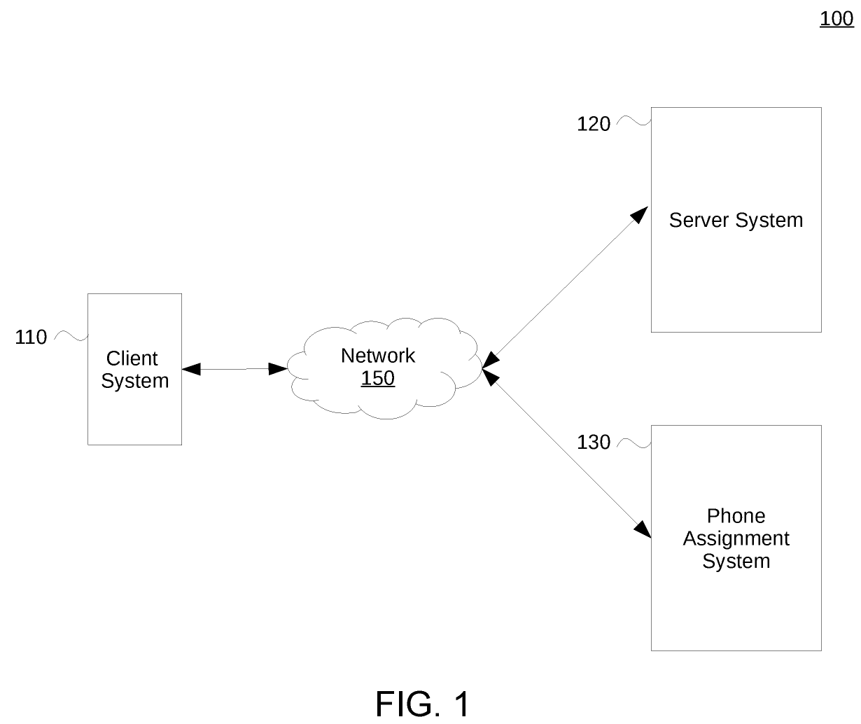

FIG. 1 shows a system environment 100 for dynamically providing a local phone number to a user based on a geolocation, according to an example embodiment. Environment 100 may include a client device 110 in communication with a server system 120 through a network 150. Environment 100 may further include a phone assignment service 130.

Client system 110 may be any computing device suitable for interacting with a server system 120, such as, by way of example, a personal computer, mobile computer, laptop computer, mobile phone, smartphone, personal digital assistant, or tablet computer. Server system 120 and phone assignment system 130 may be any combination of software and computing devices suitable to provide online services, such as, by way of example, web servers, server computers, database systems, storage area networks, application servers, or any combination thereof. The network 150 may be any communications network suitable for transmitting data between computing devices, such as, by way of example, a Local Area Network (LAN), a Wide Area Network (WAN), Metropolitan Area Network (MAN), Personal Area Network (PAN), the Internet, wireless networks, satellite networks, overlay networks, or any combination thereof.

While server system 120 and phone assignment system 130 are described as separate entities communicating over a network, this disclosure contemplates systems 120 and 130 being implemented by a single entity, or any other suitable configuration.

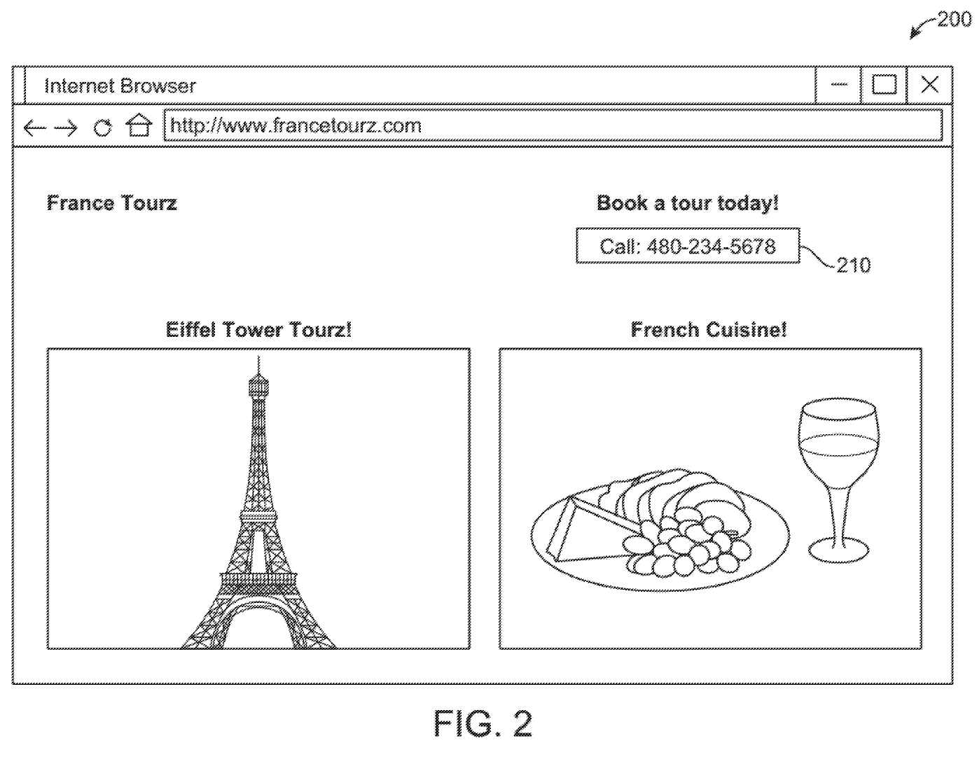

FIG. 2 illustrates an example user interface provided by server device 120 for display in client device 110, according to an example embodiment. In particular embodiments, server device 120 includes a web server that provides a webpage 200. Webpage 200 may include one or more areas 210 for displaying a phone number, for example, for contacting someone located in France associated with the webpage. In particular embodiments, a first user may access the website from a first country, for example, the U.S. As a result, this first user may see a U.S. phone number displayed on area 210 (e.g., an 1-800 number, or a number with an area code within the U.S., or an area code corresponding to the particular city the first user is located). In particular embodiments, a second user may then access the same webpage from a different country, for example, Mexico. As a result, the second user may see a Mexican phone number displayed on area 210. In particular embodiments, either user dialing their respective phone numbers may be forwarded to the same destination number, for example, in France.

While the example user interface described is a webpage, this disclosure contemplates any suitable user interface for providing information, such as a desktop application, a smartphone application, tablet application, etc.

In particular embodiments, phone assignment service 130 provides local phone numbers that are then dynamically inserted into a webpage. As an example, a webpage, such as example webpage 200, may include a piece of code (e.g., using HTML, Javascript, jQuery, etc.) that, based on a webpage visitor's location, may cause client 110 to communicate with phone assignment service 130 to retrieve a corresponding local phone number and display it on the webpage. In particular embodiments, server system 120 communicates with phone assignment service 130 to retrieve the local phone number.

In particular embodiments, an operator of server system 120 may setup an account or service agreement as a customer of phone assignment service 130. For example, phone assignment service 130 may charge fees for this service, such as per-number fees, monthly fees, etc. In particular embodiment, phone assignment service 130 may request customers to select one or more countries as part of the service agreement. As an example, an operator of server system 120 in France may enroll in dynamic phone assignment service with phone assignment service 130 for the U.S., Mexico, and Canada. If a visitor accesses a webpage 200 from one of these countries they may see a corresponding local number, but if a visitor from a different country accesses webpage 200 they may see a default number (e.g., a French phone number). Although the provision of dynamic phone assignment services are described in a particular manner, this disclosure contemplates providing dynamic phone assignment services in any suitable manner.

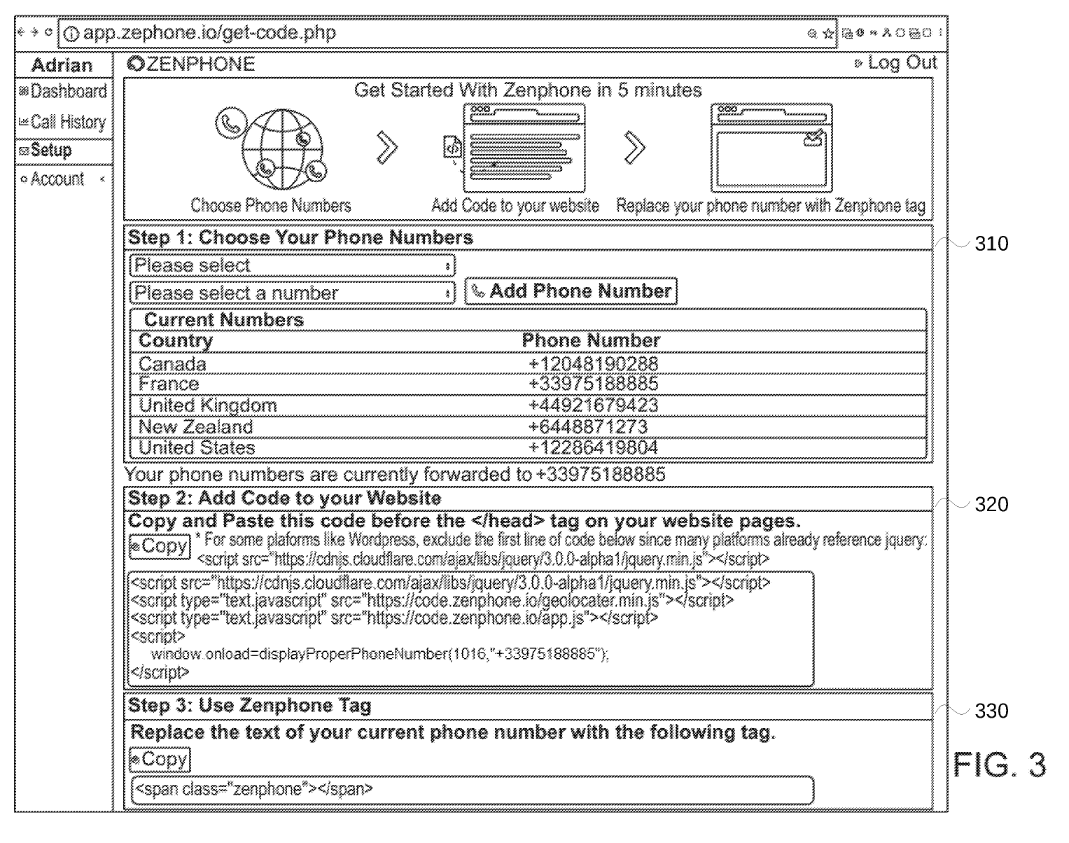

FIG. 3 illustrates a user interface 300 for a customer of phone assignment system 130, according to an example embodiment. Phone assignment system 130 may provide an interface 300 for a customer to access through a client device 110. As explained above, customer may set up an account and configure services with phone assignment system 130. For example, a customer may be an operator of a server system 120, such as a website operator.

Interface 300 may include a portion 300 for the customer to configure the countries and local phone numbers that phone assignment system 130 should provide to visitors of a server system 120. In particular embodiments, a customer may manually input the phone numbers for forwarding. In particular embodiments, a customer may select a country and phone assignment system 130 may handle the procurement and assignment of a local phone number. A customer may also input a phone number to which the calls will be forwarded to (e.g., +33975188885 in the example shown in FIG. 3).

Interface 300 may include portions 320 and 330 that instruct the operator how to configure a webpage or other system to display local phone numbers based on geolocation. In particular embodiments, a portion 320 may provide instructions and code for the customer to copy and paste into a website (e.g., javascript, jquery, etc.). The code may run whenever a visitor requests a webpage 200, and may enable and conduct communication between client device 110 and phone allocation system 130 to allow the local phone assignment. In particular embodiments, server system 120 may determine a geolocation of client device 110 based on the request (e.g., based on the client device's IP address) and include it in the webpage code. The code on the webpage then may cause client device 110 to retrieve and execute one or more scripts that transmit the geolocation of client device 110 to phone assignment system 130, and receive and display a corresponding local phone number. In particular embodiments, the scripts may also transmit an identifier associated with the customer of phone assignment system 130 (e.g., website) and an identifier of the phone number to be forwarded (e.g., for when a customer has multiple destination numbers). In particular embodiments, the one or more scripts may run on server system 120, phone allocation system 130, or any combination thereof.

As an example, the code in portion 320 of FIG. 3 calls a function using the jquery line:
window.onload=displayProperPhoneNumber(1016, “+33975188885”)

In this example, number ‘1016’ may correspond to an identifier of a particular customer of phone assignment service 130 (e.g., FranceTourz.com). The number “+33975188885” may correspond to a default phone number for display if no local phone number is available. The function may thus cause client device 110 to transmit to phone assignment system 130 the geolocation and the customer identifier. Based on this information, phone assignment system 130 may determine whether the customer is authorized based on the customer identifier and whether a local number is available based on the customer's profile, and sends the select number to the client device. If no local number is available, then a default number (e.g., destination number “+33975188885”) may be displayed.

Interface 300 may further include a portion 330 including code for a tag for the customer to copy and paste into a webpage wherever the operator wishes to display a phone number. As explained above, the tag may then be substituted for the local phone number corresponding to the particular visitor's geolocation.

Although the embodiments describe dynamically displaying local phone numbers on a webpage based on geolocation, this disclosure contemplates dynamically displaying local phone numbers on any suitable interface. In particular embodiments, client device 110 may dynamically display local phone numbers on an email client. As an example, client device 110 may be configured to automatically include a signature at the bottom of newly created emails (e.g., Best regards, John Smith, France Tourz.com, Expert Tour Guide). In particular embodiments, the signature may include a dynamically generated local phone number based on the techniques thus described. As an example, the local phone number may be based on a geolocation of the client device, on an IP address of a sender of an email to which the new email is replying to, an email address, etc. An email application may be any suitable email client, such as a desktop application, mobile application, a web-based email client, etc.

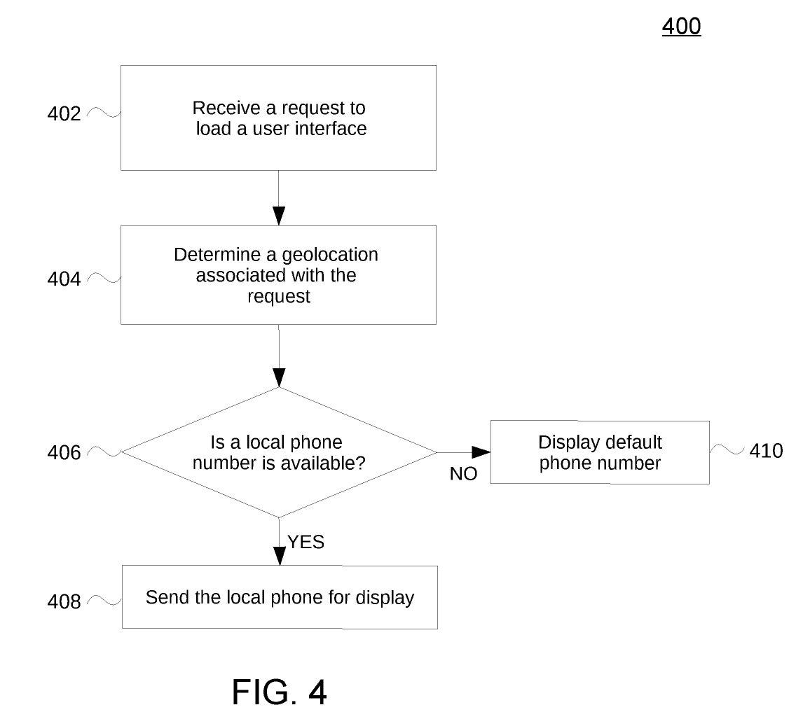

FIG. 4 illustrates a method 400 for dynamically providing a local phone number to a user based on a geolocation, according to an example embodiment. At step 402, server system 120 receives a request to load a user interface over network 150 (e.g., an HTTP request to load a webpage). At step 404, server system 120 determines a geolocation associated with the request. As an example, server system 120 may determine a geolocation corresponding to an IP address associated with the request. In particular embodiments, server system 120 may request that the user provide a geolocation, for example, through any suitable geolocation services. As an example, a user may be prompted to share the user's location (e.g., “FranceTourz.com would like to access your location. Do you want to allow this?”). When the user accepts, client device 110 may communicate the device's location. In particular embodiments, client device 110 may determine its location through a configuration of the device, through a Global Positioning System equipment, or any other suitable means.

At step 406, client device 110 or server system 120 may request whether a local phone number associated with the geolocation is available. As an example, server system 120 may transmit a snippet of code to a web browser on client 110 that when executed calls an application programming interface (API) to communicate with phone assignment system 130. The API call may include information representing the determined geolocation of the user and an identifier, login, or other authentication information associated with server system 120. For example, the geolocation information may be an area code, a zip code, a city, a region, a country, etc. In particular embodiments, server system 120 may execute code that retrieves the local phone number and transmit a webpage or other interface to client device 110 for display of the number. In particular embodiments, server system 120 may determine a number is not available without querying phone assignment service 130, for example, because of prior knowledge of the countries for which local numbers are available.

Phone assignment service 130 may query a database (e.g., an SQL database) to determine whether a local phone number is available for the geolocation and customer. The local phone number may be a phone number that has an area code or country code associated with the geolocation (e.g., a Phoenix, AZ area code for a visitor with an IP address associated with Phoenix). In particular embodiments, phone assignment system 130 maintains a pool of phone numbers local for particular countries and associated with each server system 120 subscribed to phone assignment service. Availability of a local phone number may depend one or more factors, for example, whether the country is serviced by system 130, whether a number is available from a number pool, whether the user server subscription choices include the requested country, etc. As an example, if an operator of server system 120 subscribed for local phone assignment services for U.S., Canada, and Mexico, but a visitor is geolocated in Argentina, the API call to local phone assignment system 130 may respond with an indication that no local phone number is available.

At step 408, if a local phone number is available, phone allocation system 130 sends the local phone number to server system 120 or client device 110 for display. In particular embodiments, a snippet of code on a webpage served by service device 120 populates a variable or tag (e.g., a DIV or SPAN tag ID) with the retrieved local phone number. At step 410, if a local phone number was unavailable, client device 110 displays a default phone number. In particular embodiments, the local or default phone number displayed is included on the webpage as an interactive hyperlink that the user can activate to initiate a call, for example, through a smartphone or external application (e.g., Skype, Google Voice, etc.).

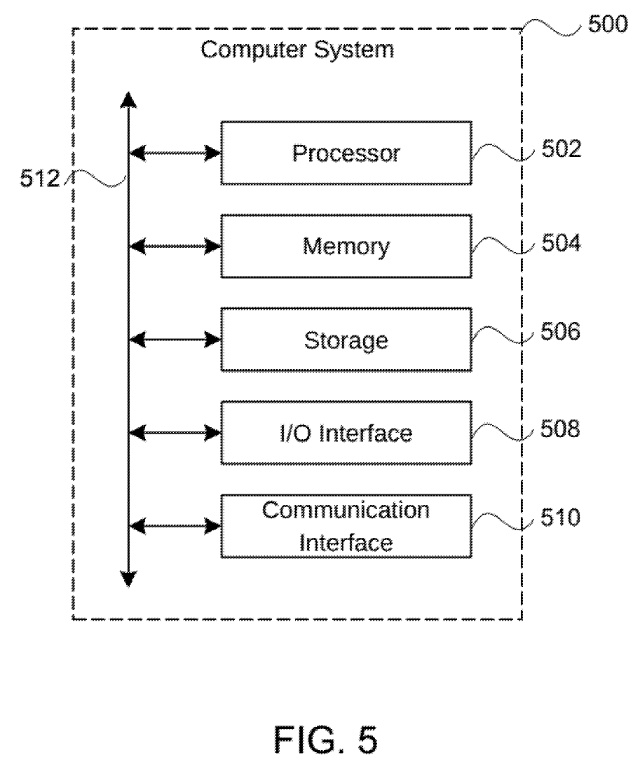

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example, computer system 500 may be an embedded computer system, a desktop computer system, a laptop or notebook computer system, a mainframe, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, memory 504 includes random access memory (RAM). This RAM may be volatile memory, where appropriate Memory 504 may include one or more memories 504, where appropriate. Although this disclosure describes and illustrates particular memory, this disclosure contemplates any suitable memory.

In particular embodiments, storage 506 includes mass storage for data or instructions. As an example, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A computer implemented method comprising, by at least one processor:
receiving, from a client device through a communications network, a first request for content;
determining a geolocation of a client device based on information included in the request;
sending, to the client device through the communications network, instructions that cause the client device to:
send a second request, the second request comprising the determined geolocation;
receive a phone number selected from a pool of phone numbers based on the geolocation; and
display the selected phone number on an interface.

2. The method of claim 1, wherein the determining the geolocation of the client device comprises determining the geolocation based on an internet protocol (IP) address of the client device.

3. The method of claim 1, wherein the geolocation comprises a code associated with a city, a region, a country, or a zip code.

4. The method of claim 1, wherein the selected phone number comprises a number that is local to the determined geolocation of the client device.

5. The method of claim 4, wherein the selected phone number comprises a number with an area code or a country code corresponding to the determined geolocation.

6. The method of claim 1, wherein the request comprises a hypertext transfer protocol (HTTP) request for a webpage, and the instructions comprise one or more scripts embedded in the webpage.

7. The method of claim 6, wherein the instructions further populate one or more tags on the webpage with the selected phone number, the populating causing the selected phone number to be displayed on a location corresponding to the one or more tags.

8. A system, comprising:
a memory; and
at least one processor coupled to the memory and configured to:
receive, from a client device through a communications network, a first request for content;
determine a geolocation of a client device based on information included in the request;
send, to the client device through the communications network, instructions that cause the client device to:
send a second request, the second request comprising the determined geolocation;
receive a phone number selected from a pool of phone numbers based on the geolocation; and
display the selected phone number on an interface.

9. The system of claim 9, wherein to determine the geolocation of the client device the at least one processor is further configured to determine the geolocation based on an internet protocol (IP) address of the client device.

10. The system of claim 9, wherein the geolocation comprises a code associated with a city, a region, a country, or a zip code.

11. The system of claim 9, wherein the selected phone number comprises a number that is local to the determined geolocation of the client device.

12. The system of claim 11, wherein the selected phone number comprises a number with an area code or a country code corresponding to the determined geolocation.

13. The system of claim 9, wherein the request comprises a hypertext transfer protocol (HTTP) request for a webpage, and the instructions comprise one or more scripts embedded in the webpage.

14. The method of claim 13, wherein the instructions further populate one or more tags on the webpage with the selected phone number, the populating causing the selected phone number to be displayed on a location corresponding to the one or more tags.

15. A tangible computer-readable device having instructions stored thereon that, when executed by at least one computing device, causes the at least one computing device to perform operations comprising:
receiving, from a client device through a communications network, a first request for content;
determining a geolocation of a client device based on information included in the request;
sending, to the client device through the communications network, further instructions that cause the client device to:
send a second request, the second request comprising the determined geolocation;
receive a phone number selected from a pool of phone numbers based on the geolocation; and
display the selected phone number on an interface.

16. The computer-readable device of claim 15, wherein the determining the geolocation of the client device comprises determining the geolocation based on an internet protocol (IP) address of the client device.

17. The computer-readable device of claim 15, wherein the geolocation comprises a code associated with a city, a region, a country, or a zip code.

18. The computer-readable device of claim 15, wherein the selected phone number comprises a number that is local to the determined geolocation of the client device.

19. The computer-readable device of claim 18, wherein the selected phone number comprises a number with an area code or a country code corresponding to the determined geolocation.

20. The computer-readable device of claim 15, wherein the request comprises a hypertext transfer protocol (HTTP) request for a webpage, and the further instructions comprise one or more scripts embedded in the webpage.
